(19) United States
(12) Patent Application Publication
(10) Pub. No.: US 2026/0178053 A1
(43) Pub. Date: Jun. 25, 2026

(54) METHOD FOR GENERATING MAP MARKER, ROBOT AND SYSTEM

(71) Applicant: LINGDONGKEJI (BEIJING) CO., LTD, Beijing (CN)

(72) Inventor: Tingting XU, Beijing (CN)

(21) Appl. No.: 19/432,946

(22) Filed: Dec. 25, 2025

(30) Foreign Application Priority Data
Dec. 25, 2024 (CN) 2024119322617

(51) Int. Cl. G05D 1/661; B66F 9/06; G01C 21/00; G05D 1/246; G05D 105/28

(52) U.S. Cl. CPC G05D 1/661; G01C 21/3811; G05D 1/246; B66F 9/063; G05D 2105/28

(57) ABSTRACT

Provided are a method for generating a map marker, a robot, a system and a corresponding device. The method for generating a map marker includes a step of execution, a step of parsing and a step of generation. In the step of execution, a movement control process is executed at least once, where the movement control process includes: controlling a robot to move to a target point, and acquiring sensing data of the robot at the target point in each movement control process. In the step of parsing, location information corresponding to the target point is parsed out on the basis of the sensing data. In the step of generation, a map marker of the target point on a map is generated on the basis of the sensing data. The method for generating a map marker effectively saves time and resources and is more suitable for robots.

### TECHNICAL FIELD

The present invention relates to the technical field of robots, in particular to, a method for generating a map marker, a robot, a system and a corresponding electronic device.

### BACKGROUND

At present, in the working scenarios of robots, it is necessary to plot various map markers on a map to allow the robots to perform tasks on the basis of the map and corresponding markers. According to an existing method, the markers are manually and directly plotted on the map online. However, such a marker plotting method often has the problem of inconsistency between map markers and actual operating position of robots (marker error). A solution to this problem is to measure the map markers one by one and set an offset, such that the robots can rectify the marker error to complete a task such as such as parking or docking at a target point. However, since a map often involves a large number of map markers, no matter whether the markers are manually plotted one by one or the markers are measured one by one and the offset is set, a huge amount of work will be caused, leading to a great waste of time and resources.

### SUMMARY

The application aims to provide a solution to generating a map marker based on a robot to solve or at least relieve the aforesaid problems in the prior art.

Specifically, in a first aspect, the present invention provides a method for generating a map marker, including:
a step of execution: executing a movement control process at least once, where the movement control process includes: controlling a robot to move to a target point, and acquiring sensing data of the robot at the target point in each movement control process;
a step of parsing: parsing out location information corresponding to the target point on the basis of the sensing data; and
a step of generation: generating a map marker of the target point on a map on the basis of the location information.

In a second aspect, the present invention provides a robot, including:
a first control device, configured to receive an external instruction to execute a movement control process at least once, where the movement control process includes: controlling the robot to move to a target point;
a sensor device, configured to acquire sensing data of the robot and/or a surrounding environment of the robot at the target point;
a communication device, configured to upload the sensing data to a server and receive a map and a map marker of the target point from the server, where the map marker is generated on the basis of the sensing data; and
a second control device, configured to control the robot to move to the target point on the basis of the map and the map marker.

In a third aspect, the present invention provides an electronic device, including a storage device and one or more processors, where one or more programs are stored in the storage device, and the one or more programs, when executed by the one or more processors, cause the method in the first aspect to be implemented.

In a fourth aspect, the present invention provides a server for generating a map marker, including a processor, where the processor is configured to execute computer instructions to cause the server to perform:
a step of receiving sensing data uploaded by at least one robot;
a step of parsing out location information corresponding to a target point on the basis of the sensing data;
a step of generating a map marker of the target point on a map on the basis of the location information;
a step of adding the map marker onto the map; and
a step of issuing the map to the at least one robot.

In a fifth aspect, the present invention provides a system for generating a map marker, including:
The robot in the second aspect and the server in the fourth aspect.

According to the technical solution provided by the present invention, a robot is externally controlled to dynamically execute a movement control process at least once to obtain sensing data of a target point, location information corresponding to the target point is parsed out on the basis of the sensing data, and then a map marker of the target point on a map is generated on the basis of the location information, such that positioning errors caused by manual plotting may be reduced or avoided, and measurement of map markers one by one and setting of an offset are not needed, thus greatly reducing the workload and saving time and resources. In addition, the map marker generated according to the technical solution provided by the present invention is more suitable for robots, as compared with manually plotted markers.

### BRIEF DESCRIPTION OF THE DRAWINGS

Non-restrictive and non-exhaustive embodiments of the present invention are described below by way of examples with reference to the following drawings. Where:

FIG. 1 illustrates a flowchart of a method for generating a map marker according to one embodiment of the present invention.

FIG. 2 illustrates a flowchart of a method for generating a map marker according to another embodiment of the present invention.

FIG. 3-1 illustrates a stereogram of a robot according to one embodiment of the present invention.

FIG. 3-2 illustrates a front view of a fork side of the robot according to one embodiment of the present invention.

FIG. 4 illustrates a block diagram of a system for generating a map marker according to one embodiment of the present invention.

### DETAILED DESCRIPTION OF EMBODIMENTS

To better clarify the above and other features and advantages of the present invention, the present invention is further described below in conjunction with accompanying drawings. It should be understood that the specific embodiments provided here are merely for the purpose of explanation to those skilled in the art and are illustrative rather than restrictive.

In the following description, many specific details are expounded to provide a full understanding of the present invention. However, it is obvious for those ordinarily skilled in the art that the present invention may be implemented without these specific details. In other circumstances, well-known steps or operations are not detailed to avoid ambiguities of the present invention.

The term “and/or”, if used here, indicates the inclusion of any one of related items listed and any combination of two or more related items listed.

“Robot” mentioned in the present invention may also be referred to as “autonomous mobile robot”, “intelligent robot” and “automated guided vehicle” and should be broadly understood as autonomous vehicles used in various environments, including but not limited to, mobile robots, such as self-navigation mobile robots, inertial navigation robots, remote-control mobile robots and/or robots guided by laser targeting, a visual system and/or road signs. The robot in the present invention should not be construed as an autonomous vehicle driven on outdoor roads because there is a great difference between these two both in the positioning technique and in positioning precision, and these two should not be simply substituted by each other.

“Map marker” mentioned in the present invention refers to a special sign marked on a map for robots and should be broadly understood as a sign that is designed for or may be used for movement, navigation or docking of robots. The map marker generally corresponds to a physical location in a site where a robot moves, such as a stop (where the robot stops), a pallet docking point (where the robot forks a pallet), a path (along which the robot moves), a region (where the robot performs a regional task). Various information, including pose information, of the corresponding physical location is recorded in the map marker. After receiving a task, the robot parses out a task location and a corresponding map marker according to the task, navigates to the task location on the basis of the pose information in the map marker, and performs task actions at the task location.

In a typical scenario, the robot is a transfer robot, a target point is a transfer docking point, and the location information includes pose information of the transfer docking point (i.e., pose information of a docking device corresponding to the transfer docking point). For example, in a case where a forklift robot moves to a first pallet docking point to be docked with a pallet, a map includes a map marker corresponding to the first pallet docking point, and the map marker includes pose information and docking information of the first pallet docking point. The pose information includes (x, y) coordinates, orientation and angle of the pallet location in a map coordinate system, and, if necessary, also includes offset information, and the offset information includes actual offset coordinates and angle of the pallet location.

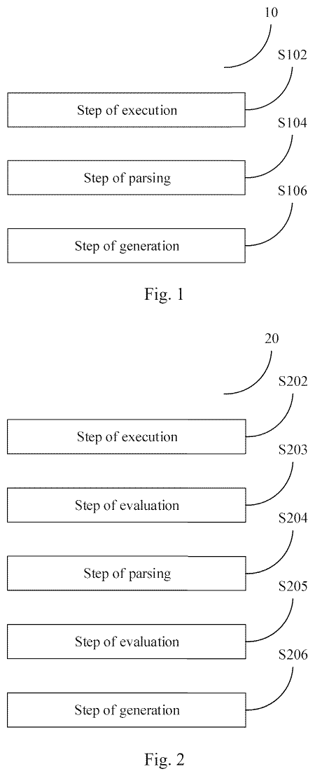

FIG. 1 illustrates a method 10 for generating a map marker according to one embodiment of the present invention. The method 10 includes a step S102 of execution, a step S104 of parsing, and a step S106 of generation.

In the step S102 of execution, a movement control process is executed at least once, where each movement control process includes: controlling a robot to move to a target point, and acquiring sensing data of the robot at the target point in each movement control process.

The robot may be various types of robots, such as a steering wheel mobile robot or a differential wheeled robot, and the robot may receive a movement instruction and move to the target point. Here, the movement instruction may be in various forms. The movement instruction may be a movement instruction from a robot control system, and the robot moves to the target point autonomously (autonomous positioning and navigation) according to the instruction. The movement instruction may also be from a remote control device or an on-board driving system, and the robot moves to the to the target point non-autonomously.

The robot is provided with an on-board sensor system, including one or more of an odometer, a gyroscope, a camera, a lidar, an ultrasonic sensor, an infrared sensor and other sensors capable of sensing the robot or the surrounding environment of the robot. Optionally, a site sensor system, such as one or more of a surveillance camera, a contact detection sensor, a lidar, an ultrasonic sensor and an infrared sensor, may be deployed in the site.

In one embodiment, a driver drives the forklift robot to the second pallet docking point by means of the on-board driving system, to fork a pallet (or place a pallet). First, the driver controls the robot to move to a suitable pallet docking position and then controls the robot to fork (or place) a pallet. After moving to the target point, the robot acquires sensing data of the on-board senor system and/or the site sensor system. As mentioned above, the sensing data is one or more of odometer data, laser point cloud data, and image data captured by the camera.

In the step S104 of parsing, location information corresponding to the target point is parsed out on the basis of the sensing data. The sensing data is sensing data of the robot and/or the surrounding environment of the robot. In one embodiment, pose information of the robot may be parsed out from the sensing data. For example, in one embodiment, the pose information of the robot at the target point may be parsed out from odometer data obtained by moving the robot from a known position to the target point. For example, in another embodiment, the pose information of the robot at the target point may be parsed out on the basis of the laser point cloud data and a SLAM positioning algorithm. Pose information of the pallet location may be parsed out on the basis of the pose information of the robot, model information of the robot and model information of a pallet, for example, by coordinate relation transformation between rigid bodies.

In another embodiment, the pose information of the pallet location may be parsed out directly by means of sensing data of the pallet location. In one embodiment, multiple sets of sensing data of the pallet before and after being forked by the forklift may be obtained, the sensing data in each set is different, for example, in data source and data range, and the multiple sets of sensing data are fused to parse out the pose information of the pallet location.

In another embodiment, the pose information of the pallet location parsed out in the above two embodiments may be fused.

In the step S106 of generation, a map marker of the target point on a map is generated on the basis of the location information. In one embodiment, a map marker corresponding to the second pallet docking point is generated on the map, and pose information of the second pallet docking point in the map marker is set as the pose information of the pallet location parsed out in the step S104. In another embodiment, the map is searched for the map marker corresponding to the second pallet docking point, and offset information of the second pallet docking point in the map marker is set as the offset coordinates and angle calculated on the basis of the pose information of the pallet location and the pose information of the second pallet docking point parsed out in the step S104.

In another embodiment, the robot is also controlled to execute a movement control process for placing (or forking) the pallet at the second pallet docking point and fuse sensing data acquired in the current movement control process and the sensing data acquired in the previous movement control process for forking (or placing) the pallet to perform the step of parsing and the step of generation. In this way, differential errors caused by merely placing or forking the pallet may be eliminated, and the consistency between the map marker corresponding to the second pallet docking point and the action of forking or placing the pallet is maintained, thus making the map marker more suitable for the robot.

FIG. 2 illustrates a method 20 for generating a map marker according to another embodiment of the present invention. The method 20 includes a step S202 of execution, a step S204 of parsing, a step S206 of generation, a step S203 of evaluation and/or a step S205 of evaluation. The step S202 of execution and the step S204 of parsing are completely the same as the step S102 of execution and the step S104 of parsing.

In the step S203 of evaluation, at least one piece of sensing data is evaluated according to a preset evaluation criterion to obtain a score of the at least one piece of sensing data. In one embodiment, the movement control process in the step of execution is executed at least twice, and the sensing data acquired in each movement control process is evaluated according to the preset evaluation criterion to obtain the score of the sensing data acquired in each movement control process. In one embodiment, the score of the sensing data may be obtained according to the degree of matching between a known object in the surrounding and the sensing data, and a higher degree of matching indicates a high accuracy of the sensing data and a higher score. For example, at least one reflective stripe is arranged on the surface of a fixed object in the vicinity of the pallet docking point, and the reflective stripe is accurately marked on the map; and the degree of matching between the sensing data of the lidar and the reflective stripe is calculated, and a higher degree of matching indicates a higher score. In another embodiment, the consistency of sensing data acquired in more than two movement control processes may be evaluated, the score of sensing data in line with the evaluation criterion of consistency is set to be greater than the preset score, and the score of sensing data not in line with the evaluation criterion of consistency is set to be lower than the preset score. Finally, only the sensing data with the score greater than the preset score is used for performing the step 204 of parsing and the step 206 of generation, to generate the map marker.

In another embodiment, the step S205 of evaluation is performed after the step S204 of parsing. The movement control process in the step of evaluation is executed at least three times, sensing data acquired in each movement control process may be different, for example, in data source and data range, and the step of parsing is performed on the sensing data acquired in each movement control process to parse out multiple pieces of location information. The consistency of the multiple pieces of location information is evaluated, the score of the sensing data corresponding to the location information in line with the evaluation criterion of consistency is set to be greater than the preset score, and the score of sensing data not in line with the evaluation criterion of consistency is set to be lower than the preset score. Finally, only the location information parsed out on the basis of the sensing data with the score greater than the preset score is used for performing the step 206 of generation, to generate the map marker.

In one embodiment, in the absence of the sensing data with the score greater than the preset score in the step of evaluation, the step of execution, the step of parsing and the step of evaluation are performed again until the score greater than the preset score is obtained by evaluation, and then the step of generation is performed.

In one embodiment, in the step of execution, sensing data of the robot in the movement control process is acquired, a set of location information of the robot is acquired on the basis of the sensing data acquired in the movement control process, and docking information in the map marker is generated on the basis of the location information, where the docking information is used for assisting the robot in determining a docking process. In one embodiment, a docking trajectory of the robot is generated on the basis of the set of the location information and added to the map marker as the docking information, such that the robot, which moves to the map marker to perform a docking task, implements docking according to the docking trajectory. In another embodiment, critical docking path points of the robot are generated on the basis of the set of location information and added to the map as the docking information, such that the robot, which moves to the map marker to perform a docking task, implements docking according to the critical docking path points.

In another embodiment, in the step of execution, the sensing data of the robot at the target point in each movement control process further includes sensing data of an on-board docking device. For example, in one embodiment, sensing data of up-down, left-right or front-back displacement of forks of the forklift may be acquired. In another embodiment, sensing data of up-down displacement of a lifting module of a lifting robot may be acquired. The docking information in the map marker may also be generated on the basis of these data, and the robot, which moves to the map marker to perform the docking task, controls the docking device to implement docking according to the docking information.

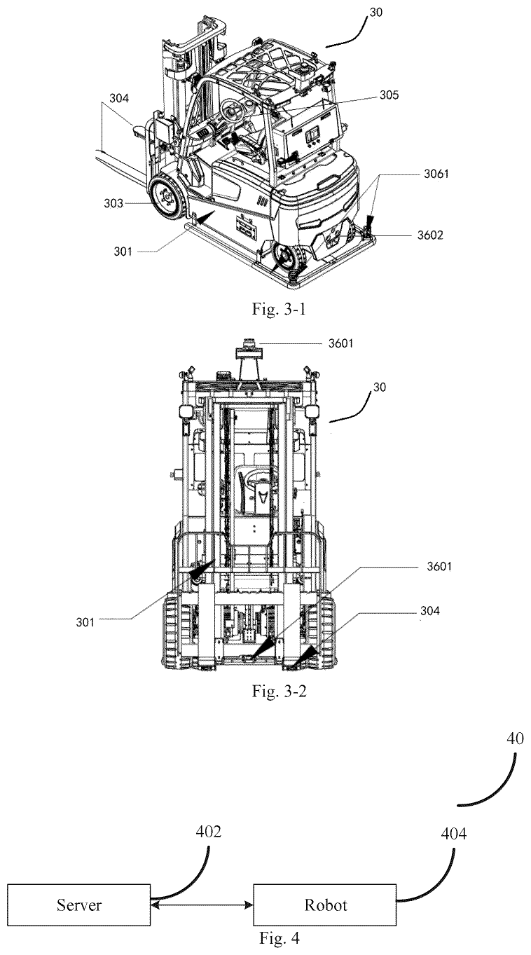

Referring to FIGS. 3-1 and 3-2 illustrate a stereogram of a robot 30 according to one embodiment of the present invention and a front view of a fork side of the robot 30 according to one embodiment of the present invention, the robot 30 includes: a body 301 (a body of a forklift in this embodiment), a power device 302, a moving device 303 (wheels of the forklift in this embodiment), a docking assembly 304 (forks of the forklift in this embodiment), a first control device 305, a sensor device 306, a communication device 307, and a second control device 308. Where, the power device (302) and the second control device 308 are typically located inside the body 301. The moving device 303, the docking assembly 304 and the first control device 305 are typically located outside the body 301. Parts of the sensor device 306 and the communication device 307, such as an odometer and a network card, may be located inside the body 301; and parts of the sensor device 306 and the communication device 307, such as a camera 3061, a lidar 3062 and an antenna, may be located outside the body (301).

The first control device 301 is connected to the power device 302 and configured to receive an external instruction to execute a movement control process at least once, where the movement control process includes: driving the power device 302 to control the robot to move to a target point. In this embodiment, the first control device 301 is an on-board artificial driving system, including, but not limited to, a steering wheel for manually controlling the forklift and the forks, a control lever, a control button, a control pedal and other necessary components. In another embodiment, the first control device is a manual remote-control device, and the remote-control device includes, but is not limited to, a control switch, a direction control joystick, a fork control lever, a scram button and other necessary control elements.

In another embodiment, the first control device 301 controls the docking assembly 304 to complete docking, for example, the first control device 301 controls the forks to fork or place a pallet.

The sensor device 306 is configured to acquire sensing data of the robot and/or the surrounding environment of the robot at the target point, and includes, but is not limited to, one or more of an odometer, a gyroscope, a camera, a lidar, an ultrasonic sensor, an infrared sensor, a contact sensor and other sensors capable of sensing the robot or the surrounding environment of the robot. In this embodiment, the sensor device 306 includes the camera 3061 and the lidar 3062.

The communication device 307 is configured to upload the sensing data to a server and receive a map and a map marker of the target point from the server, where the map marker is generated on the basis of the sensing data. In another embodiment, information of the map marker is included on the map, and the communication device receives the map from the server. In another embodiment, the communication device 307 is also configured to receive a task from the server and feed task execution condition back to the server.

The second control device 308 is electrically connected to the sensor device 306, the communication device 307 and the power device 302 and configured to control the sensor device (306) to acquire sensing data, control the communication device 307 to upload the sensing data and receive a map and a map marker and drive the power device 302 on the basis of the map and the map marker. The second control device 308 is generally configured as an industrial personal computer. It may be understood that the second control device 308 may also be other electronic devices with an operational capacity, a storage capacity and a communication capacity. In one embodiment, a robot control system is installed and runs in the second control device 308, such that the second control device 308 is able to automatically analyze a map and task acquired from the server and control the robot to complete automatous positioning, navigation and docking on the basis of the map and the task to execute the task without manual intervention.

The method for generating a map marker provided by the present invention may be implemented by a server for generating a map marker. FIG. 4 illustrates an example of the server 402. The server 402 is suitable for communicating with a specific number of robots 404. The number of the robots 404 may be one or more according to specific circumstances. The server 402 and the robot 404 form a system 40 for generating a map marker according to the present invention.

In one embodiment, the server 402 sends instructions to any one robot 404 in communication with the server 402 to instruct the robot 404 to execute positioning, navigation, docking and other control processes and receives a variety of feedback information reported by the robot 404 in the movement control process. The feedback information includes sensing data reported by the robot 404 at a target point. The server 402 parses out location information corresponding to the target point on the basis of the sensing data and generates a map marker of the target point on a map on the basis of the location information. The target point may be various points, related to the task, in the site, especially a docking target point of the robot. The server 402 generates a map including map markers corresponding to all points in the site and sends the map to all the robots 404 that perform the task in the site.

In another embodiment, the server 402, after issuing the map to all the robots 404 that perform the task in the site, sends the task to any one robot 404 in communication with the server 402. The robot 404 parses out the target point corresponding to the task and autonomously navigates to the target point to complete the task. In another embodiment, the robot 404 also parses out actions corresponding to the task, for example, controlling docking, controlling a lifting device to ascend or descend, controlling a sensor to acquire sensing data, and completes corresponding actions at the target point.

The method for generating a map marker provided by the present invention may be implemented by a system formed by the server for generating a map marker and the robot in related embodiments. All aspects, steps, operations, details and elements of the method for generating a map marker provided by the present invention are suitable for the server and system provided by the present invention. Particularly, the server provided by the present invention is provided with a processor, which is configured to execute computer instructions to cause any one or any combination of the steps and operations of the method for generating a map marker provided by the present invention to be performed.

In one embodiment, an electronic device is provided, including a storage device and one or more processors, where one or more processors to be executed by the one or more processors are stored in the storage device, and the one or more programs, when executed by the one or more processors, cause the steps of the method provided by the present invention to be performed. The electronic device may be broadly understood as a server, a terminal or any other electronic devices with a necessary computation and/or processing capacity. In one embodiment, the electronic device may include a processor, a memory, a network interface and a communication interface which are connected by means of a system bus. The processor of the electronic device is configured to provide a necessary computation, processing and/or control capacity. The storage device of the electronic device may include a nonvolatile storage medium and an internal memory. An operating system and a computer program are stored in or on the nonvolatile storage medium. The internal memory may provide an environment for running of the operating system and the computer program in the nonvolatile storage medium. The network interface and the communication interface of the electronic device may be in connection and communication with an external device by means of a network. The computer program, when executed by the processor, causes the steps of the method provided by the present invention to be performed.

The present invention may be implemented as a computer-readable storage medium, storing computer instructions, where the computer instructions, when executed by a processor, causes the steps of the method provided by the present invention to be performed. In one embodiment, the computer instructions are distributed in a plurality of electronic devices or processors which are coupled by means of a network, such that the computer instructions may be stored, accessed and executed in a distributed manner by one or more electronic devices or processors. Each step/operation of the method, or two or more steps/operations of the method may be performed by one electronic device or processor or by two or more electronic devices or processors. One or more steps/operations of the method may be performed by one or more electronic devices or processors, and one or more other steps/operations of the method may be performed by one or more other electronic devices or processors. One or more electronic devices or processors may perform one step/operation of the method or may perform two or more steps/operations of the method.

Those ordinarily skilled in the art may understand that the all or part of the steps of the method provided by the present invention may be completed by related hardware instructed by computer instructions such as an electronic device or a processor. The computer instructions may be stored in a non-transient computer-readable storage medium, and the computer instructions, when executed, cause the steps of the method provided by the present invention to be performed. According to specific circumstances, any citations of a memory, a storage device, or a database or other media may include nonvolatile and/or volatile memories. The nonvolatile memories include, for example, a read-only memory (ROM), a programmable ROM (PROM), an electrically programmable ROM (EPROM), an electrically erasable ROM (EEPROM), a flash memory, a magnetic tape, a floppy disk, a magnetic-optical data storage device, an optical data storage device, a hard disk, a solid-state disk, etc. The volatile memories include, for example, a random access memory (RAM), an external cache buffer memory, etc.

The technical features described above may be combined freely. Although not all possible combinations of the technical features are described, any combinations of these technical features should be construed as being included in the specification as long as the combinations are not contradictory.

Although the present invention is described in conjunction with embodiments, those skilled in the art should understand that the above description and drawings are merely illustrative rather than restrictive, and the present invention is not limited to the embodiments disclosed above. Various transformations and modifications are available without departing from the spirit of the present invention.

What is claimed is:

1. A method for generating a map marker, comprising:
a step of execution: executing a movement control process at least once, wherein the movement control process comprises: controlling a robot to move to a target point, and acquiring sensing data of the robot at the target point in each movement control process;
a step of parsing: parsing out location information corresponding to the target point on the basis of the sensing data; and
a step of generation: generating a map marker of the target point on a map on the basis of the location information.

2. The method according to claim 1, further comprising:
a step of evaluation: evaluating at least one piece of said sensing data according to a preset evaluation criterion to obtain a score of the at least one piece of sensing data; and
performing the step of parsing and the step of generation on the basis of the sensing data with the score greater than a preset score, to generate the map marker.

3. The method according to claim 2, wherein in the absence of the score greater than the preset score, the step of execution, the step of parsing and the step of evaluation are performed again until the score greater than the preset score is obtained by evaluation, and then the step of generation is performed.

4. The method according to claim 1, wherein the sensing data comprises sensing data indicating pose information of the robot.

5. The method according to claim 1, wherein the robot comprises a transfer robot, and/or
the target point comprises a transfer docking point, and/or
the location information comprises pose information of the transfer docking point.

6. The method according to claim 2, wherein the sensing data comprises sensing data indicating pose information of the robot.

7. The method according to claim 3, wherein the sensing data comprises sensing data indicating pose information of the robot.

8. The method according to claim 2, wherein the robot comprises a transfer robot, and/or
the target point comprises a transfer docking point, and/or
the location information comprises pose information of the transfer docking point.

9. The method according to claim 3, wherein the robot comprises a transfer robot, and/or
the target point comprises a transfer docking point, and/or
the location information comprises pose information of the transfer docking point.

10. The method according to claim 4, wherein the robot comprises a transfer robot, and/or
the target point comprises a transfer docking point, and/or
the location information comprises pose information of the transfer docking point.

11. A robot, comprising:
a first control device, configured to receive an external instruction to execute a movement control process at least once, wherein the movement control process comprises: controlling the robot to move to a target point;
a sensor device, configured to acquire sensing data of the robot and/or a surrounding environment of the robot at the target point;
a communication device, configured to upload the sensing data to a server and receive a map and a map marker of the target point from the server, wherein the map marker is generated on the basis of the sensing data; and
a second control device, configured to control the sensor device to acquire the sensing data and control the robot to move to the target point on the basis of the map and the map marker.

12. The robot according to claim 11, further comprising:
a body, a power device arranged in the body, a moving device arranged at a bottom of the body and driven by the power device, and a docking assembly arranged on the body;
wherein, the first control device is a remote control device or an on-board driving system, and/or the second control device is an industrial personal computer;
the first control device and the second control device are electrically connected to the power device;
the second control device is electrically connected to the sensor device and the communication device;
the docking assembly is docked with a docking device at the target point.

13. A system for generating a map marker, comprising:
at least one robot according to claim 11; and
a server, configured to receive the sensing data uploaded by the at least one robot, parse out location information corresponding to the target point on the basis of the sensing data, generate the map marker of the target point on the map on the basis of the location information, add the map marker onto the map, and send the map to the at least one robot.

14. The system according to claim 13, wherein the server sends a docking task to the robot, and the rotor performs the docking task on the basis of the map.
